(19) United States
(12) Patent Application Publication
(10) Pub. No.: US 2005/0175294 A1
(43) Pub. Date: Aug. 11, 2005

(54) Optical transceiver and fabrication method thereof

(75) Inventor: Wien-Haurn Kuu, Taoyuan Hsien (TW)

Correspondence Address: BIRCH STEWART KOLASCH & BIRCH, PO BOX 747, FALLS CHURCH, VA, 22040-0747, US

(73) Assignee: Delta Electronics, Inc.

(21) Appl. No.: 11/050,796

(22) Filed: Feb. 7, 2005

(30) Foreign Application Priority Data
Feb. 6, 2004 (TW) 93102705

(51) Int. Cl. G02B 6/42

(52) U.S. Cl. 385/88

(57) ABSTRACT

An optical transceiver. The optical transceiver comprises a circuit structure, an optical fiber with a core, a light guiding component, and a cover. The cover connects the core and the light guiding component by adhesion, dot welding, or laser welding. Part or all of, the optical fiber is covered with a filled material, and the core is capable of transmitting optical signals. The light guiding component is directly connected to the circuit structure for receiving or transmitting optical signals.

### BACKGROUND

The invention relates to an optical transceiver, and in particular to an optical transceiver with a low-cost improved fabrication process.

FIG. 1 shows a conventional optical transceiver 100. In FIG. 1, a planar light wave circuit (PLC) 104 is disposed on a ceramic substrate 102 with an opening 108. The input side of the PLC 104 is aligned with the opening 108. An optical fiber 106 is inserted into the opening 108 and fixed at an optical inlet of the PLC 104 by adhesion. The ceramic substrate 102 is fixed on a printed circuit board (PCB) by pins. The conventional optical transceiver as described above, however, have a relatively high fabrication cost due to the ceramic substrate.

FIG. 2 shows another conventional optical transceiver 200. In FIG. 2, an optical fiber 202 is inserted into a zirconia ferrule 204 covered by a copper flange 206. A PLC 208 is fixed on a ceramic substrate 210. A core 220 of the optical fiber 202 is disposed in a V-shaped slot of the PLC 208, aligning with a waveguide incident surface of the PLC 208. A fiber cover 212, covering the core 220 of the optical fiber 202, is disposed on the PLC 208 by welding. The PLC 208 and the ceramic substrate 210 are electrically connected by wiring. The ceramic substrate 210 and the flange 206 are connected and adhered to a base 216. The ceramic substrate 210 is electrically connected to the PCB 218 by the pins 214 protruding from the ceramic substrate 210.

Although the second fabrication process reduces the consumption of the ceramic material, the cost is still significant due to the use of the ferrules and flanges. The ferrules and flanges are high-priced components, and the ceramic material cannot be eliminated in the second fabrication process. Furthermore, the second fabrication process requires three more steps than the first fabrication process. Therefore, the second fabrication process is more difficult and costs more time.

### SUMMARY

Accordingly, embodiments of the invention provide an optical transceiver capable of reducing fabrication time and cost.

Embodiments of the invention additionally provide an optical transceiver capable of simplifying fabrication process and reducing cost without any heat-resistant material.

Embodiments of the invention further provide an optical transceiver comprising a circuit structure, an optical fiber with a core, a light guiding component, and a cover. The cover connects the optical fiber and the light guiding component by adhesion, dot welding, or laser welding. Part of, or all of, the optical fiber is covered with a fixed element, and the core is capable of transmitting optical signals. The light guiding component is directly connected to the circuit structure for receiving or transmitting optical signals.

Moreover, embodiments of the invention provide another optical transceiver comprising a circuit structure, a light transmission assembly, a light guiding component, and a cover. The cover connects the light transmission assembly and the light guiding component by adhesion, dot welding, or laser welding. The light transmission assembly comprises a fixed element and an optical fiber. Part of the optical fiber is covered with a filled material, and the optical fiber is capable of transmitting optical signals. The light guiding component is directly connected to the circuit structure for receiving or transmitting optical signals.

In the optical transceiver of each embodiment, the light transmission assembly or the fixed element can be directly fixed on the circuit structure or fixed by a housing. Additionally, the fixed element is disposed in another housing before positioning, and the circuit structure and the light transmission assembly are then connected and positioned. The fixing method is adhesion, meshing, embedding, integrally forming, press fitting, clipping, or filling with stuffing material. The filled material comprises plastic, resilient material, stuffing material, metal, or a material softer than that of the fixed element. The material of the fixed element comprises metal, alloy, plastic, or other material with rigidity higher than the optical fiber.

Furthermore, the light guiding component and the cover are disposed on one surface of the circuit structure, and the positioned housing is disposed on the same surface or on the opposite surface of the circuit structure. Moreover, the light guiding component, the cover, and the housing can also be disposed on one surface of the circuit structure.

The light guiding component is a planar light guide, laser diode, vertical cavity surface emitting laser, light emitting diode, or photodiode. The circuit structure is a printed circuit board. The material of the cover is metal, alloy, stainless steel, ceramic, or plastic material.

Moreover, embodiments of the invention provide a method for fabricating an optical transceiver. A circuit structure with a light guiding component is first provided. An optical fiber is covered with a fixed element. The optical fiber is connected to a transmitting, or receiving portion, of the light guiding component. Finally, the light guiding component is covered with a cover by adhesion, dot welding, or laser welding to fix the optical fiber on the light guiding component, wherein part of, or all of, the optical fiber is covered with a filled material.

The fixed element is directly disposed on the circuit structure, or disposed on the circuit structure by a housing. The fixed element fixed on the housing is disposed on the circuit structure. The disposed methods are adhesion, meshing, embedding, integrally forming as a single piece, press fitting, clipping, or filling with stuffing material.

Accordingly, in embodiments of the invention, the light guiding component is directly attached to the circuit structure without a ceramic substrate. Thus, the fabrication cost and time are reduced.

Moreover, the optical fiber and the light guiding component are not connected by thermal welding. As a result, a connecting member for connecting the optical fiber and the light guiding component need not be heat-resistant material, and the optical fiber is positioned without any heat-resistant sleeve. Therefore, the fabrication cost and difficulty can be reduced.

Furthermore, a soft or resilient filled material covers the optical fiber, such that the filled material can be a damper to prevent the optical fiber from shifting, twisting or breaking.

A detailed description is given in the following embodiments with reference to the accompanying drawings.

### BRIEF DESCRIPTION OF THE DRAWINGS

Embodiments of the invention can be more fully understood by reading the subsequent detailed description and examples with references made to the accompanying drawings, wherein:

FIG. 1 is a schematic view of a conventional optical transceiver;

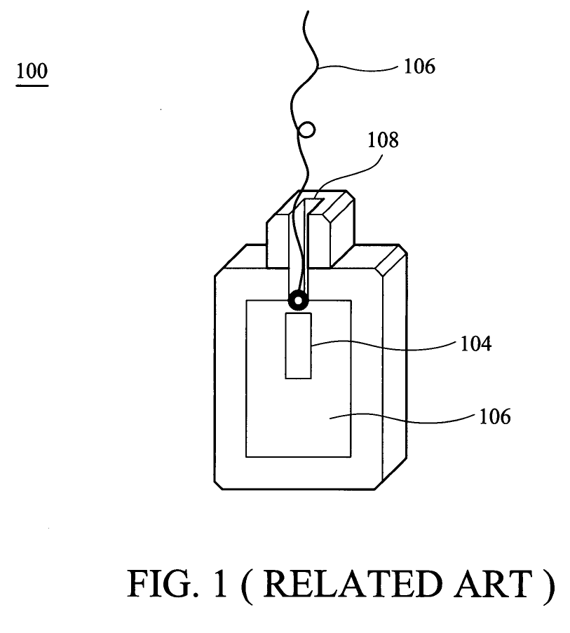

FIG. 2 is a schematic view of another conventional optical transceiver;

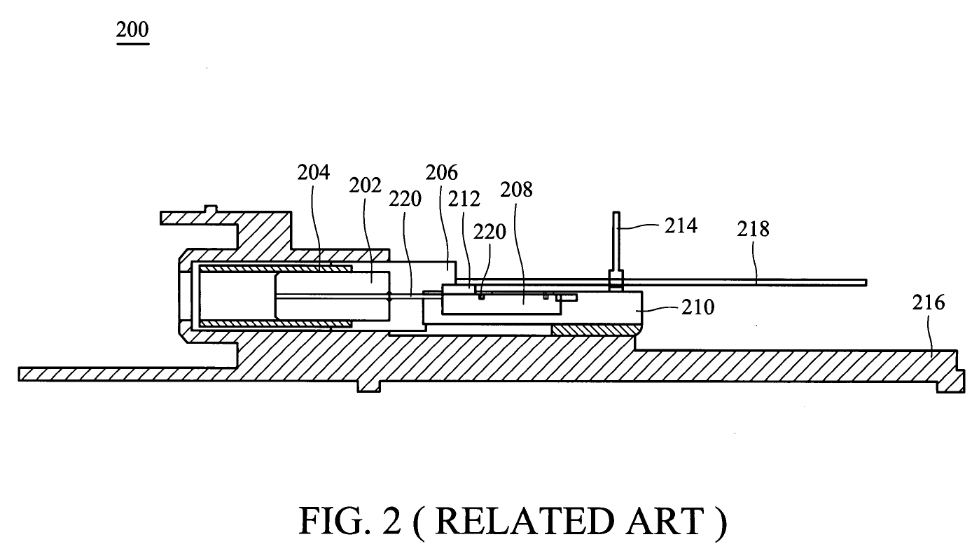

FIG. 3 is an exploded view of an optical transceiver of a first embodiment of the invention;

FIG. 4 is a schematic view of an assembly process for the optical transceiver in a first embodiment of the invention;

FIG. 5 is a schematic view of an assembly process for the optical transceiver in a second embodiment of the invention;

FIG. 6 is a schematic view of an assembly process for the optical transceiver in a third embodiment of the invention;

FIG. 7 is a schematic view of an assembly process for the optical transceiver in a fourth embodiment of the invention;

FIG. 8 is a partial view of an optical transceiver in each embodiment of the invention.

### DETAILED DESCRIPTION

### First Embodiment

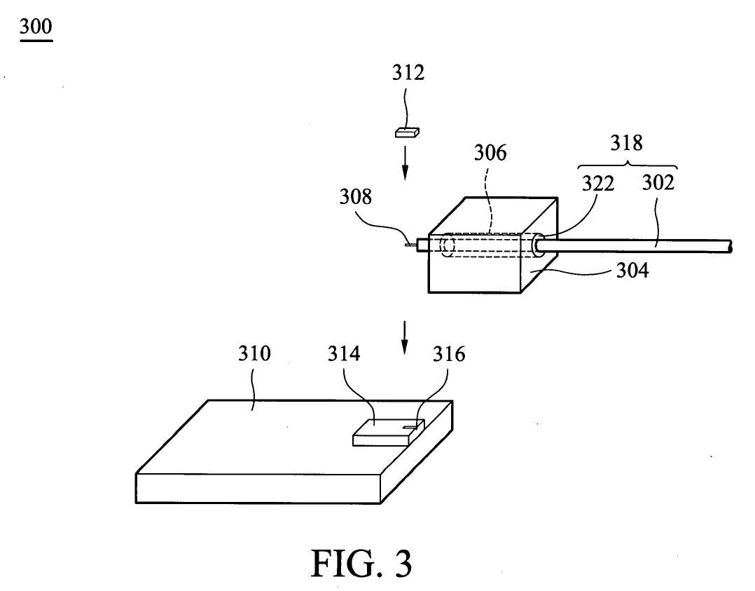

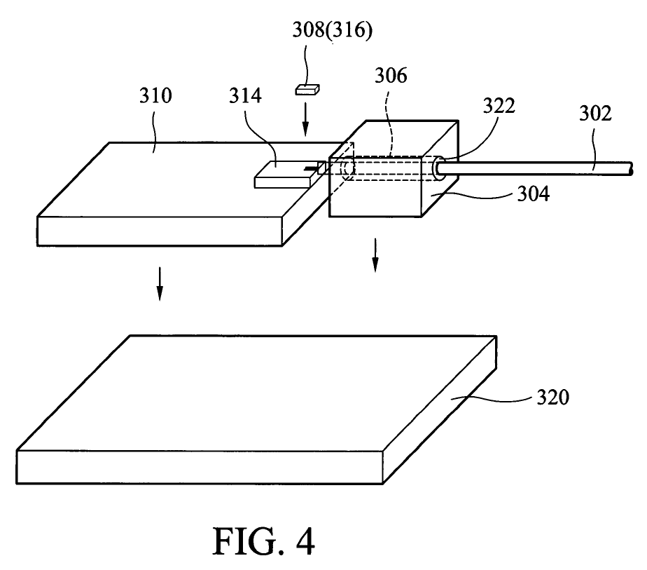

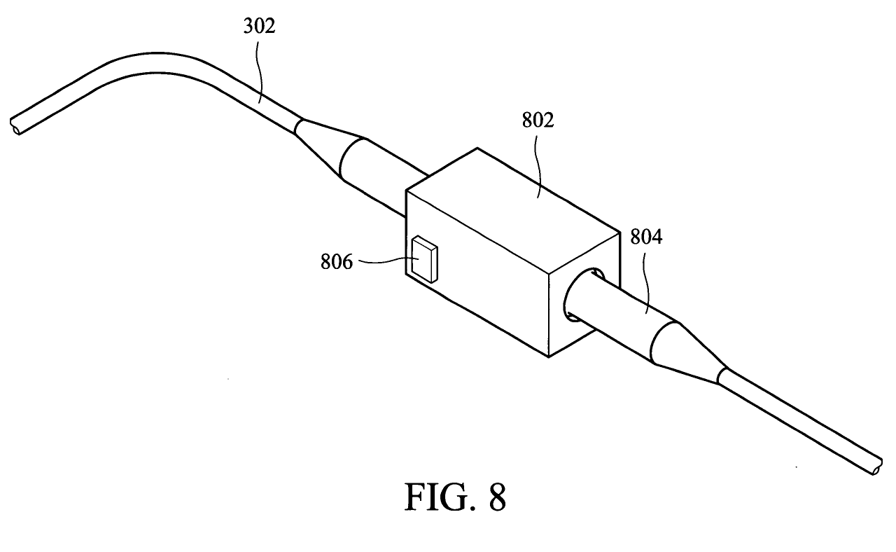

FIG. 3 is an exploded view of an optical transceiver 300 of a first embodiment of the invention. The optical transceiver 300 includes a light guiding component 314, a light transmission assembly 318 and a circuit structure 310. A cover 312 connects the light guiding component 314 and light transmission assembly 318. One edge of the cover 312 connects to the light guiding component 314. The light guiding component 314 is connected to the cover 312 by adhesion, dot welding, or laser welding. The material of the cover 312 is metal, stainless steel, plastic, alloy, or ceramic material. Furthermore, the optical transceiver 300 is disposed in a fixed element 304 and a housing 320 as shown in FIG. 4. The fixed element 304 and housing 320 are integrally formed as a single piece or detachable. The material of the fixed element 304 and housing 320 is metal, stainless steel, plastic material, alloy, ceramic material, or a material having rigidity higher than the optical fiber. The fixed element 304 and housing 320 are connected by adhesion, meshing, embedding, integrally forming as a single piece, press fitting, or clipping. Furthermore, an opening 306 is defined on a central axis of the fixed element 304 to receive the light transmission assembly 318. The fixed element 304 is conical, tubular, polygonal, a rectangular fixed element 802 with a securing portion 806 as shown in FIG. 8, or other housing with at least one securing portion.

The light transmission assembly 318 includes an optical fiber 302 and a filled material 322 covering the optical fiber 302. The optical fiber 302 comprises a core 308, transmitting optical signals. The core 308 of optical fiber 302 is an internally reflectional structure provided for reflecting optical signals forward. For example, the core 308 is a total reflectional solid structure or total reflectional hollow structure.

The filled material 322 covers part, or all of the optical fiber 302 and is disposed between the optical fiber 302 and the fixed element 304 to fix the light transmission assembly 318 in the opening 306 of the fixed element 304. The shape of the filled material 322 is corresponding to the shape of the opening 306 of the fixed element 304, tubular, polygonal, conical, horn structure 804 as shown in FIG. 8, or other structure with a securing portion. The filled material 322 is connected to the optical fiber 302 or the fixed element 304, housing 320 by adhesion, meshing, embedding, integrally forming as a single piece, press fitting, clipping, or filling with stuffing material. The material of the filled material 322 is plastic material, resilient material, stuffing material, metal, or a material softer than the fixed element 304.

Furthermore, the light transmission assembly 318 and the circuit structure 310 are simultaneously connected on the housing 320 via the fixed element 304. The light transmission assembly 318 is disposed on the circuit structure 310 via the fixed element 304, or attached to the circuit structure 310 by the filled material 322. The connecting method is adhering, meshing, embedding, integrally forming as a single piece, press fitting, or clipping.

The circuit structure 310 drives and controls the light guiding component 314 or is driven or controlled by the light guiding component 314. For example, the circuit structure 310 is a printed circuit board. The light guiding component 314 is directly attached to the circuit structure 310. The light guiding component 314 is capable of receiving optical signals from the light transmission assembly 318 and transforming optical signals into other signals, such as electrical signals, or transforming other types of signals into optical signals conveyed to the light transmission assembly 318. The light guiding component 314 is attached to the circuit structure 310 by wire bonding, integral forming as a single piece, or meshing. Integral forming as a single piece means that the optical component 314 and the circuit structure 310 are fabricated simultaneously or separately in the same structure.

The light guiding component 314 is a planar light guide, laser diode, vertical cavity surface emitting laser, light emitting diode, or photodiode. The light guiding component 314 further includes an opening 316 to position the light transmission assembly 318. The opening 316 receives one end of the core 308, aligning with the transmitting or receiving portion of the light guiding component 314.

Additionally, the light guiding component 314, the cover 312, and the housing 320 are disposed on the same side surface of the circuit structure 310. Additionally, the light guiding component 314 and the cover 312 also can be disposed on the same surface of the circuit structure 310, and the housing 320 is disposed on an opposite surface of the circuit structure 310.

FIG. 4 is a schematic view of the assembly process for the optical transceiver 300 in the first embodiment of the invention. First, the light guiding component 314 is electrically connected to the circuit structure 310 by wire bonding. The optical fiber 302 through the housing 304 protrudes out of the fixed element 304. The space between the optical fiber 302 and the fixed element 304 is filled with the filled material 322, such that the optical fiber 302 can be fixed in the fixed element 304.

Next, the circuit structure 310 and the fixed element 304 are separately attached to the housing 320. The core 308 of the optical fiber 302 is disposed in the opening 316, connecting the transmitting or receiving portion of the light guiding component 314. The cover 312 covers the opening 316 and is fixed on the light guiding component 314 by adhesion, dot welding, or laser welding. Thus, the optical fiber 302 is fixed by the cover 312 and the light guiding component 314.

Furthermore, the circuit structure 310 and the fixed element 304 are connected and positioned on the housing 320 by adhesion, meshing, embedding, welding, or clipping.

According to the method of the first embodiment, the light transmission assembly and the light guiding component can be easily connected and positioned. Because the process of connection need not require the high temperature thermal welding, some components in the optical transceiver can be plastic materials which are inexpensive and facilitate fabrication.

Moreover, the soft or resilient filled material covers the optical fiber, such that the filled material can be a damper to protect the optical fiber from shifting, twisting or breaking.

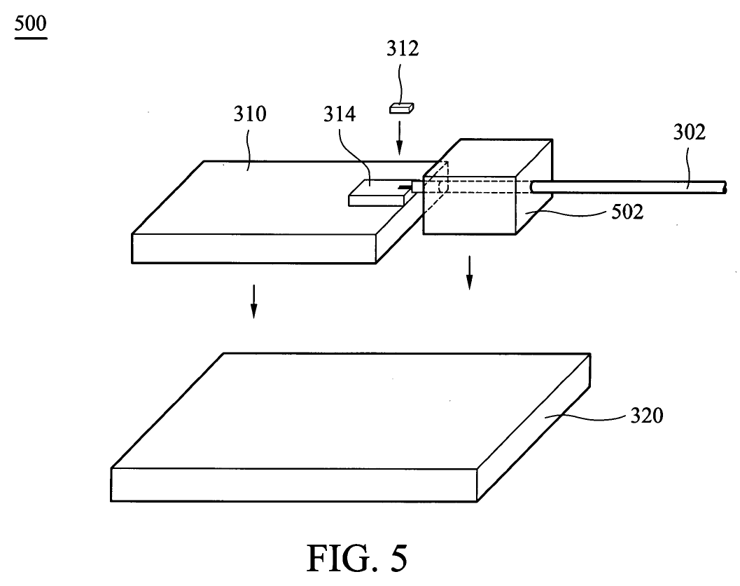

FIGS. 5˜7 show several assembly processes for fabricating optical transceivers.

### Second Embodiment

FIG. 5 shows an assembly process for the optical transceiver in a second embodiment of the invention. A filled material 502 is used as the fixed element 304 as mentioned FIG. 3 for protecting and positioning the light transmission assembly. The filled material 502 is integrally formed as a single piece around the optical fiber 302, clamping or engaging the optical fiber 302 in the filled material 502. The filled material 502 prevents vibration and shifting of the optical fiber due to the flexibility of this structure. Furthermore, cost and duration of the method can be reduced due to eliminating the fixed element 304 as shown in FIG. 3.

### Third Embodiment

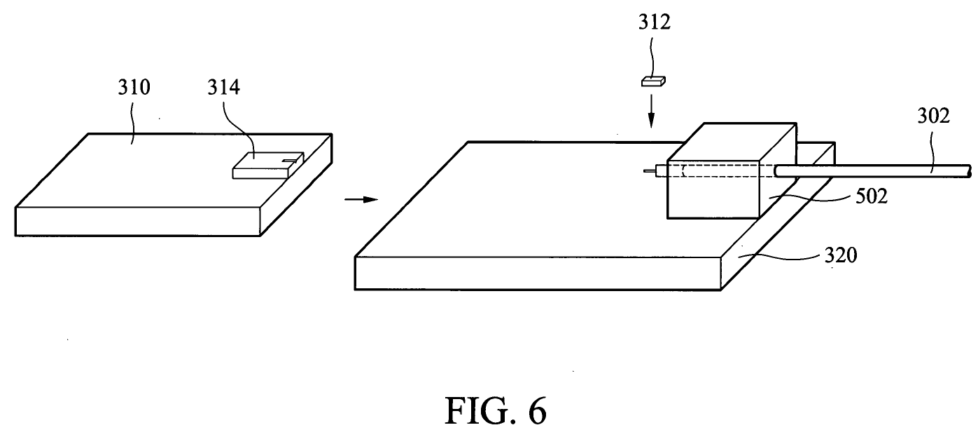

FIG. 6 is a schematic view of an assembly process for the optical transceiver in a third embodiment of the invention. During this third assembly process, the filled material 502 and the housing 320 are integrally formed as a single piece, or directly attached each other in advance first. Subsequently, the circuit structure 310 with the light guiding component 314 is connected with the optical fiber 302. The connections between the cover 312 and the light guiding component 314 or the circuit structure 310 and the housing 320 are processed simultaneously or individually, and other fabrication processes are similar to the method mentioned in FIG. 4. The optical fiber 302 may be positioned in the filled material 502 (or the fixed element 304 in FIG. 3) before, simultaneously or after that the filled material 502 (or the fixed element 304 in FIG. 3) is attached to the housing 320.

### Fourth Embodiment

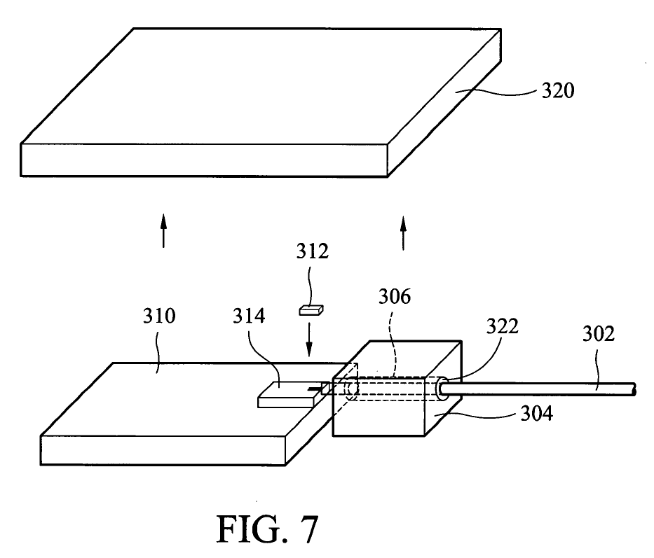

FIG. 7 shows an optical transceiver assembly process of the fourth embodiment of the invention. In the fourth embodiment, the housing 320 is connected to the surface of the circuit structure 310 comprising the light guiding component 314, and other fabrication processes are similar to the method mentioned in FIG. 4. The fourth embodiment provides a clipping force between the cover 312 and the light guiding component 314 such that the optical fiber 302 is securely connected with the transmitting or receiving portion of the light guiding component 314.

The light guiding component 314 and the circuit structure 310 are connected by a clip without requiring the housing 320. Moreover, the filled material 502 and the fixed element 304 are directly attached to the circuit structure 310.

Accordingly, in embodiments of the invention, the light guiding component is directly attached to the circuit structure without requiring the use of a ceramic substrate therebetween, thus the fabrication cost and time are reduced.

Moreover, the optical fiber and the light guiding component are not connected by thermal welding. As a result, the connecting member between the optical fiber and the light guiding component need not be a heat-resistant material, and the optical fiber can be positioned without requiring any heat-resistant sleeve. Thus, fabrication cost and difficulty can be reduced.

Furthermore, the soft or resilient filled material covers the optical fiber, such that the filled material can be a damper, protecting the optical fiber from shifting, twisting or breaking.

While embodiments of the invention have been described by way of examples and in terms of the preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An optical transceiver, comprising:
a circuit structure;
a light transmission assembly for transmitting optical signals;
a light guiding component directly connected to the circuit structure, and receiving or transmitting optical signals; and
a cover connecting an end of the light transmission assembly to the light guiding component.

2. The optical transceiver as claimed in claim 1, further comprising:
a fixed element with an opening, connecting to the circuit structure, and the light transmission assembly is disposed in the opening.

3. The optical transceiver as claimed in claim 2, wherein the light transmission assembly comprises:
an optical fiber passing through the opening and transmitting optical signals thereby.

4. The optical transceiver as claimed in claim 3, wherein the light transmission assembly comprises:
a filled material being disposed between the optical fiber and the fixed element, fixing the optical fiber in the opening.

5. The optical transceiver as claimed in claim 4, wherein the filled material is plastic, resilient material, stuffing material, metal, or a material softer than that of the fixing element.

6. The optical transceiver as claimed in claim 4, wherein the filled material connects the fixing element or the optical fiber by adhesion, meshing, embedding, integrally forming as a single piece, press fitting, or clamping.

7. The optical transceiver as claimed in claim 4, wherein the shape of the filled material is conical, tubular, polygonal, the shapes corresponding to the shape of the opening, or other structure with a securing portion.

8. The optical transceiver as claimed in claim 2, wherein the material of the fixed element is metal, alloy, plastic material, or a material with rigidity higher than the optical fiber.

9. The optical transceiver as claimed in claim 2, wherein the light guiding component and the cover are disposed on a first surface of the circuit structure, and the fixed element is disposed on the first surface or on a second surface of the circuit structure opposite to the first surface.

10. The optical transceiver as claimed in claim 1, wherein the material of the cover is metal, alloy, ceramic, or plastic material.

11. The optical transceiver as claimed in claim 1, wherein the cover is connected to the light guiding component by adhesion, dot welding, or laser welding.

12. The optical transceiver as claimed in claim 1, wherein the light guiding component is a planar light guide, light emitting diode, laser diode, vertical cavity surface emitting laser, or photodiode.

13. The optical transceiver as claimed in claim 1, further comprising:
a housing fixing the circuit structure and the light transmission.

14. The optical transceiver as claimed in claim 13, wherein the cover is between the circuit structure and the housing.

15. A method for fabricating an optical transceiver, comprising steps of:
providing a circuit structure with a light guiding component;
covering an optical fiber with a fixed element;
connecting the optical fiber with an transmitting portion or a receiving portion of the light guiding component correspondingly; and
fixing the optical fiber on the light guiding component with a cover.

16. The method as claimed in claim 15, further comprising a step of fixing the circuit structure and the fixed element on a housing, wherein the housing and the cover are disposed on the same surface or opposite surfaces of the circuit structure.

17. The method as claimed in claim 15, wherein the circuit structure and the fixed element are disposed on the housing by adhesion, meshing, embedding, integrally forming as a single piece, press fitting, or clamping.

18. The method as claimed in claim 15, further comprising steps of:
disposing a filled material in the fixed element; and
fixing the circuit structure and the fixed element on a housing, the housing and the cover disposed on the same surface or opposite surfaces of the circuit structure.

19. The method as claimed in claim 18, wherein the the circuit structure or the fixed element is disposed on the housing by adhesion, meshing, embedding, integrally forming as a single piece, press fitting, or clipping.

20. The method as claimed in claim 15, wherein the method of fixing the optical fiber on the light guiding component with the cover is adhesion, dot welding, or laser welding.
